(19) United States
(12) Patent Application Publication
(10) Pub. No.: US 2011/0317547 A1
(43) Pub. Date: Dec. 29, 2011

(54) METHOD AND DEVICE FOR THE RELIABLE TRANSMISSION OF DATA PACKET FLOWS WITH COMPRESSED HEADERS WITHOUT INCREASING THE FLOW RATE

(75) Inventors: Cédric Baudoin, Toulouse (FR); Fabrice Arnal, Cugnaux (FR); Jérôme Lacan, Toulouse (FR)

(73) Assignee: THALES, NEUILLY-SUR-SEINE (FR)

(21) Appl. No.: 13/255,861

(22) PCT Filed: Mar. 4, 2010
(86) PCT No.: PCT/EP10/52768

§ 371 Date: Sep. 9, 2011

(30) Foreign Application Priority Data
Mar. 13, 2009 (FR) 0901186

(51) Int. Cl. H04J 3/24; H04L 12/26

(52) U.S. Cl. 370/216; 370/474

(57) ABSTRACT

A method for robustly transmitting a data flow in the form of packets Pi including at least one header Hi, said header being compressed via a first header compression step, said packets being fragmented into a succession of cells, said cells having an identical fixed size, said fragmentation resulting in the appearance of a padding section in the last of said cells, where the space occupied by said padding section is used, at least partially, to insert redundancy data, the function of said redundancy data being to increase the robustness to transmission errors of said compressed header.

The subject of the present invention is a method and a device for improving the robustness of flows of packets with compressed headers by the insertion of redundancy without increasing the bit rate and/or the bandwidth.

The field of application of the invention is notably that of the communication networks that use the Internet protocol IP implementing network header compression techniques to the packets transmitted in order to optimize the bandwidth by eliminating the redundant information within a network header and/or between several successive network headers.

Header compression techniques are implemented on data flows, for example multimedia data, transmitted in the form of packets via a stack of protocol layers characteristic of an IP communication network. Notable among these are the network layer implementing, for example, the IP Internet protocol, the transport layer implementing, for example, the user datagram protocol (UDP) or the real-time communication protocol RTP (Real Time Transport Protocol). An effect of all these protocol layers is to add a protocol header, containing a series of information fields, to the data packets initially transmitted. The packets resulting from this stack obtained at the level of the network layer then have their size considerably increased compared to the size of the initial data packet.

An IP communication network also comprises an access network which may be a radio access network capable of transmitting the packets from the network layer to the physical communication medium which, in particular in the case of a wireless transmission, may have a constrained bandwidth. In this context in which the resources available on the transmission medium are reduced, it is known to use network header compression schemes in order to reduce the size of the packets to be transmitted without affecting the data they contain.

One of the header compression techniques known to those skilled in the art is described by the ROHC (Robust Header Compression) standard standardized by the IETF committee through RFC 3095 and related publications. This technique defines a plurality of packets compressed to different levels and a set of algorithms used, on the one hand, to compress the fields contained in the network headers and, on the other hand, to sequence the transitions between the various available compression states. Generally, the ROHC compression technique, like all the known header compression techniques, relies on the exchange of an initial context between the compressor situated on the side of the packet transmission source and the decompressor situated on the side of the recipient which receives these same packets. In a second stage, only the fields of the headers that are variable are transmitted after having been coded differentially in order to improve compression performance.

Generally, the invention applies to any device that has to send IP data flows through a transmission medium with constrained bandwidth and to do so via an access layer delivering cells of fixed size encapsulating said IP data.

One of the main problems with the header compression mechanisms introduced previously lies in the fact that the transmission of the packets may be affected by errors due notably to the propagation phenomena that occur on the physical channel. These errors may result in the loss of packets and, in the case of packets with compressed headers, may lead to a desynchronization between the compression and decompression entities. This desynchronization generally results in the loss of all the subsequent packets until the context of the decompressor is reset. The packet losses may also be linked to a congestion phenomenon resulting in a saturation of the buffer memories (also known simply as “buffers”) of the transmission medium access layer. Another characteristic of this phenomenon is that it results in bursty packet losses that are highly detrimental to maintaining the synchronization of the compression and decompression entities.

The problem then arises as to how to improve the robustness of these compression schemes in order to limit the packet losses without reducing the overall compression performance levels and without increasing the data transmission bit rate.

The known header compression techniques, such as the ROHC standard, take into account the issue of robustness to transmission errors through coding algorithms for the variable fields, for example the W-LSB (Weighted Least Significant Bit) sliding window algorithm enabling the decompressor to overcome a certain number of consecutive errors. The increase in the level of robustness of this mechanism is directly accompanied by a reduction in the compression level. Nevertheless, these algorithms do not in all cases make it possible to maintain the synchronization between the compressor and the decompressor and result in a significant implementation complexity. Finally, they do not take into account the constraints of the layers below the network layer, in particular the access layer.

In practice, in a communication network, the access layer, and especially the radio access layer, sometimes imposes a transmission of data in the form of cells, for example of ATM (Asynchronous Transfer Mode) type cells, that have a given fixed size. These cells are obtained by concatenation and/or segmentation of the network packets with compressed header which results in the use of so-called “padding” bits. These padding bits contain no useful information and are inserted solely in order to observe the a priori fixed size of the cells.

The French patent application FR 2907624 proposes a header compression method which takes into account the size of the cells of the access layer in order to minimize their number, but this method has the drawbacks of being, on the one hand, incompatible with the header compression standards commonly used in many communication network infrastructures, in particular the ROHC standard, and, on the other hand, of being less powerful in terms of compression gain than the standards deriving from the works of the IETF such as ROHC.

The present invention notably proposes exploiting the bits normally used for padding that are present in the cells generated at the level of the access layer in order to replace them with a redundant information item that makes it possible to significantly improve the robustness of the compressed network headers and to do so without degrading the overall performance levels in terms of compression gain.

To this end, the subject of the invention is a method for robustly transmitting a data flow in the form of packets Pᵢ comprising at least one header Hᵢ, said header being compressed via a first header compression step, said packets being fragmented into a succession of cells, said cells having an identical fixed size, said fragmentation resulting in the appearance of a padding section in the last of said cells, said method being characterized in that the space occupied by said padding section is used, at least partially, to insert redundancy data, the function of said redundancy data being to increase the robustness to transmission errors of said compressed header.

In a variant embodiment of the invention, said redundancy data are obtained by reducing the compression ratio applied by said first header compression step to said header Hᵢ, said compression ratio being determined from an estimation of the size of the packet with compressed header.

In a variant embodiment of the invention, said redundancy data are obtained via the following steps:
a step for determining the size of the padding section from the size of said packet with compressed header and from the fixed size of said cells,
a second step for compression of said header with a compression level making it possible to obtain a compressed header whose size is the closest possible integer less than the size of said padding section and which replaces the compressed header initially present.

In a variant embodiment of the invention, said redundancy data of said section Rⱼ are obtained from the application of a correcting code to a useful data block of length k consisting of the concatenation of all or part of one or more compressed headers, said section Rⱼ having a length rⱼ equal to that of said padding section.

In a variant embodiment of the invention, the efficiency of said correcting code is given by the ratio

$$\frac{k}{k + {r}_{j}}$$

in which k is the length of the data block to be encoded which consists of the concatenation of the compressed headers of the packets present between said padding section and the immediately preceding padding section within said transmitted data flow.

In a variant embodiment of the invention, the efficiency of said correcting code is less than a maximum efficiency

$$\frac{{k}_{ma x}}{{k}_{m ax} + {r}_{j}}$$

determined from an estimation of the ratio of packets lost during the transmission and of the performance curve of said code, the length k of said data block to be encoded being limited to a value kₘₐₓ obtained from said maximum efficiency and from the length rⱼ of said padding section.

In a variant embodiment of the invention, the efficiency of said correcting code is set to a constant value R_{c} and the dimension k of said useful data block to be encoded is obtained by the relationship

$$k = {r}_{j} \frac{{R}_{c}}{1 - {R}_{c }} ,$$

said useful data block comprising all or part of all the compressed headers Hᵢ of the packets Pᵢ present in said flow of packets to be transmitted before said padding section.

In a variant embodiment of the invention, said first header compression step implements an encoding of the fields of said header using a sliding window of size w and said useful data block comprises all or part of a subset S of all the compressed headers Hᵢ of the packets Pᵢ present before said padding section, said subset S being characterized by the fact that two consecutive headers of the subset S are separated in said flow of data to be transmitted by at least a number of headers equal to the length w of the sliding window of the protocol for implementing the header compression step.

In a variant embodiment of the invention, said correcting code is a systematic Reed-Solomon code or a systematic BCH code or a systematic Reed-Muller code, said code possibly being shortened and/or punctured.

In a variant embodiment of the invention, the ROHC protocol or the IPHC protocol is used for the header compression.

In a variant embodiment of the invention, the ATM protocol or the MPEG-TS protocol is used for said fragmentation of the packets with compressed header.

Also the subject of the invention is a system for robustly transmitting a data flow of packets with compressed headers comprising a transmitter and a receiver, characterized in that said transmitter comprises means for executing the steps of the method described previously.

Other features and advantages of the present invention will become more apparent from reading the following description in relation to the appended drawings which represent:

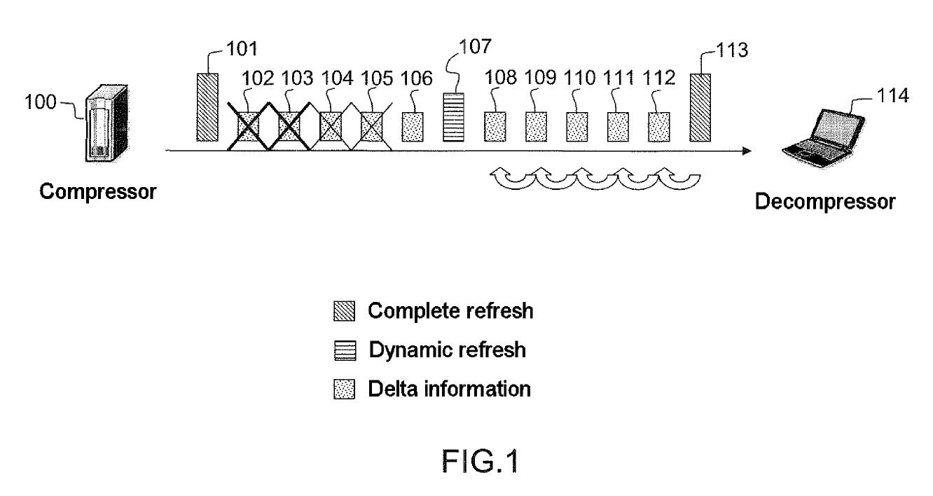

FIG. 1, an illustration of the desynchronization phenomenon due to a loss of successive packets within a flow of packets with compressed headers,

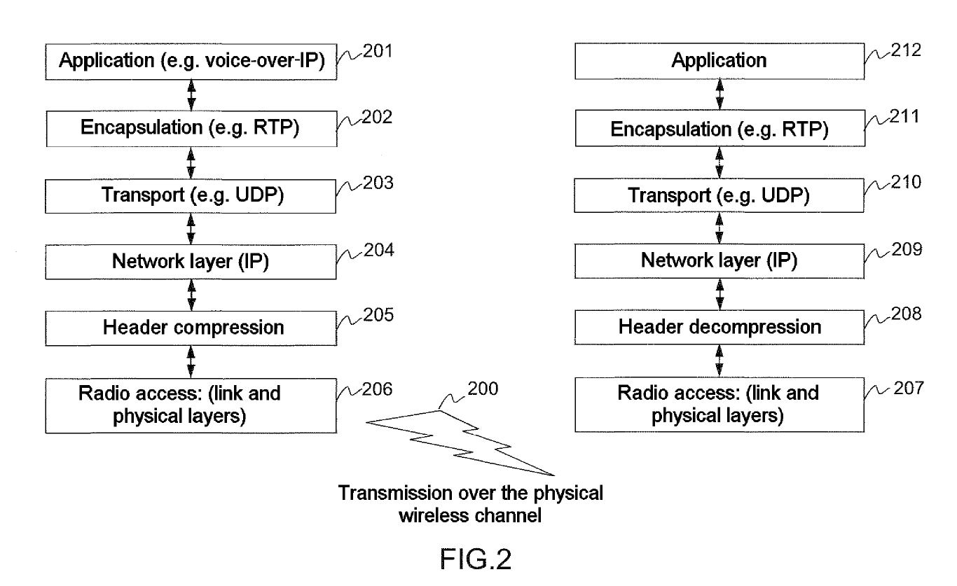

FIG. 2, a diagram of the positioning of the invention within various protocol layers implemented in the context of a transmission of packets with compressed IP headers,

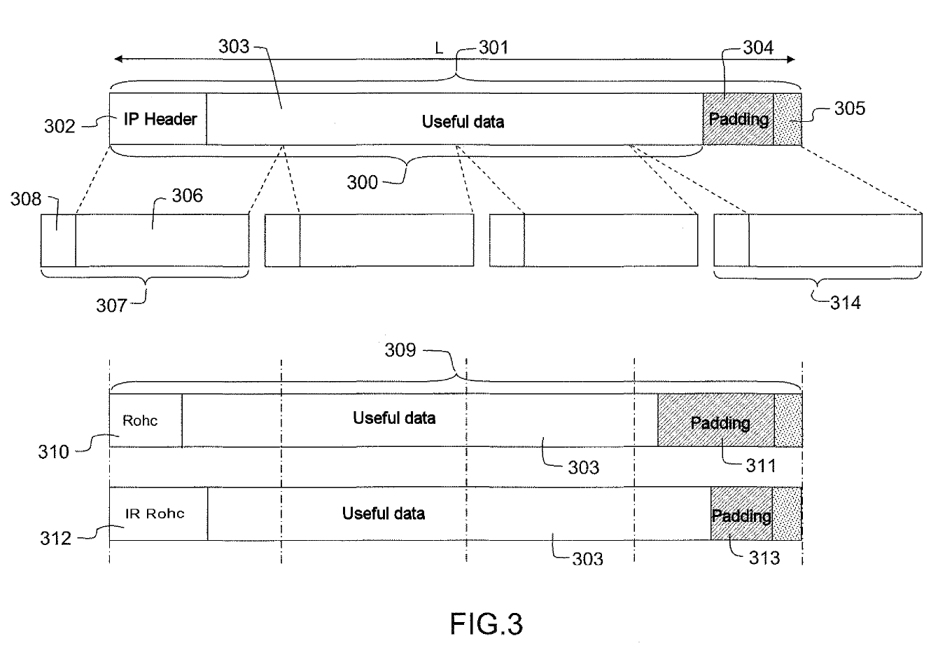

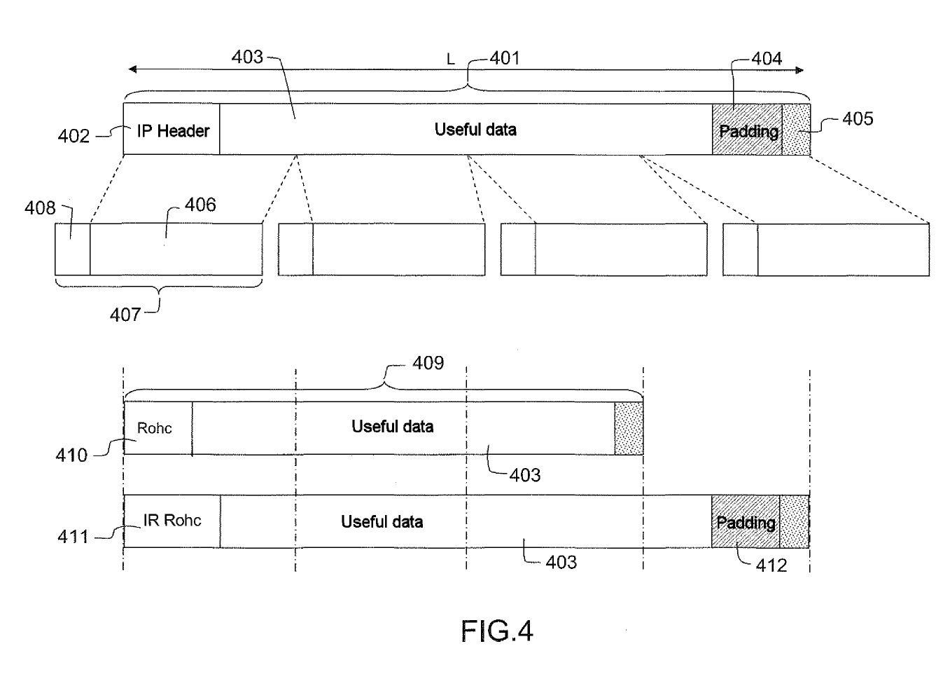

FIGS. 3 and 4, two illustrations of how the padding bits are exploited by the access layer in order to improve the robustness of the compressed header of the packet according to the invention,

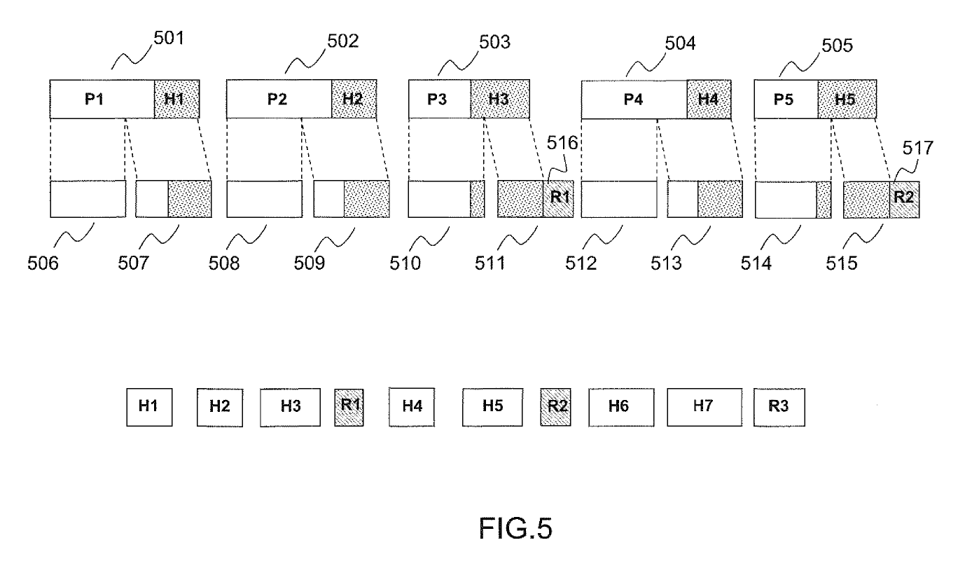

FIG. 5, a diagram representing the encapsulation of packets Pᵢ each comprising a header Hᵢ resulting in the appearance of padding sections Rᵢ,

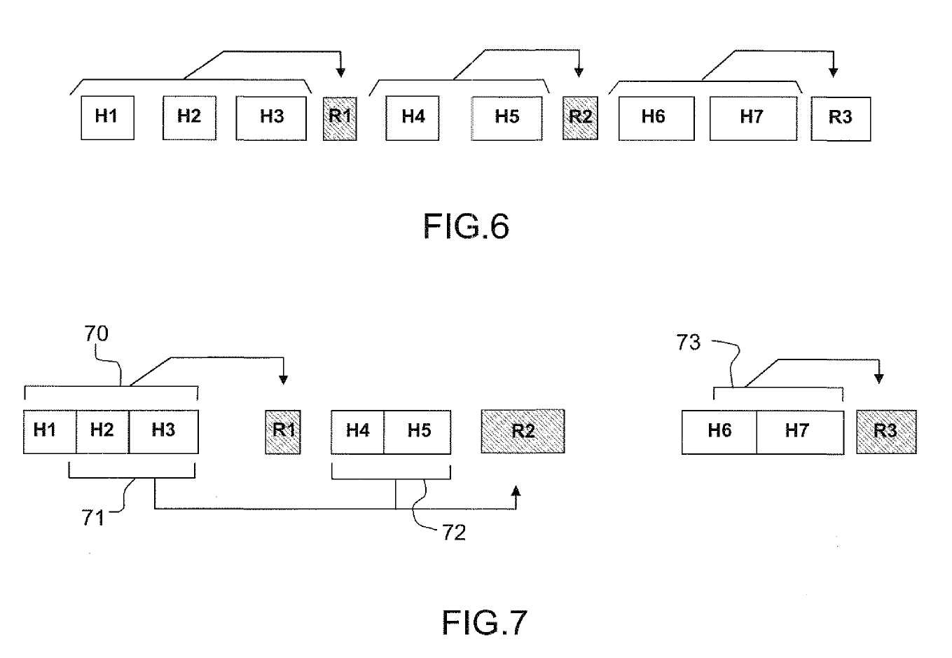

FIG. 6, a diagram representing the replacement of the padding sections Rᵢ with redundancy blocks generated from the method according to the invention,

FIG. 7, a variant embodiment of the invention for which the efficiency of the correcting code is constant, and

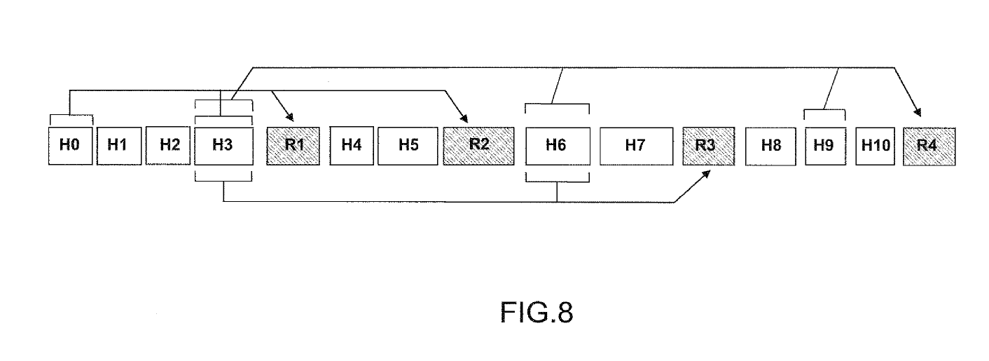

FIG. 8, a variant embodiment of the invention for which the coding scheme uses certain properties of the header compression mechanism.

In order to better understand the method according to the invention, the following description is given within the context of an application of transmission of packets with compressed IP headers implementing, for example, the ROHC protocol, through a radio access layer observing the AAL5 (ATM Adaptation Layer 5) protocol for segmentation/reassembly of the ATM cells. This context is used as an illustration and is in no way limiting, it being understood that the method according to the invention can be applied to any type of header compression mechanism and to any radio access method using a mechanism for the segmentation/reassembly of packets with compressed headers in order to produce data cells of a priori fixed size, implicitly inducing the presence of padding bits within said cells. In particular, the use of the MPEG-TS (Moving Picture Expert Group-Transport Stream) standard is also compatible with the present invention. In practice, the latter defines, in particular, the encapsulation of multimedia data in packets intended for transport through an Internet protocol communication network. Worth citing, finally, is the case of the DVB-S2 (Digital Video Broadcasting Satellite-Second Generation) standard which is compatible with the present invention when it comes to the encapsulation of packets with compressed headers in physical layer frames standardized under the name “BBFrames”.

Furthermore, there are other header compression methods to which the invention can also be applied, in particular the IPHC (IP Header Compression over PPP) protocol standardized via RFC 2509 by the IETF standardization committee. The rest of the description is given by taking the example of the ROHC protocol, it being understood that any other header compression mechanism is also compatible with the invention.

FIG. 1 illustrates a scenario, according to the prior art, for the transmission of packets with compressed headers, subjected to errors and its influence on the overall robustness of the header compression method.

A terminal 100 implementing a known header compression mechanism, for example a mechanism conforming to the ROHC standard, transmits a flow of packets whose headers 101-113 vary in size according to the compression level that is applied to them. The header 101 corresponds to a complete refresh of the context enabling the compressor 100 and the decompressor 114 to remain synchronized. The headers 102, 103, 104, 105, 106 are then transmitted with a compression level that is higher than that used to compress the refresh header 101 by coding the information fields differentially relative to the preceding packet. If an error, due for example to nonreliability of the transmission link or to packet congestion phenomena, appears on the header 102, the context of the decompressor 114 is no longer up-to-date and a desynchronization occurs potentially resulting in the loss of all the subsequent packets with compressed header 103, 104, 105, 106 until a packet is received that includes a dynamic refresh header 107 which makes it possible to update the context of the decompressor 114. The subsequent packets 108, 109, 110, 111, 112 can then once again be compressed with a higher compression level than that used to compress the header 107.

From the above illustration, it can be seen that observing the compression gain performance levels of the existing network header compression mechanisms leads to a significant sensitivity to errors possibly leading to significant packet losses within a transmitted data flow to which said mechanisms are applied.

FIG. 2 diagrammatically represents the various steps of the protocol stack that is undergone by a data packet generated by an application layer 201 implementing, for example, a multimedia voice-over-IP or video content broadcasting application. The data packets generated by the application layer 201 are then transmitted to the lower encapsulation 202, transport 203 and network 204 layers which in turn add a specific protocol header to said data packet. The protocols implemented within the layers 202, 203 and 204 are, for example, respectively the RTP, UDP and IP protocols. A standard header compression mechanism including a step for improving robustness according to the invention is implemented within the header compression layer 205. The method according to the invention uses certain information originating from the radio access layer 206, in particular the size of an ATM cell, in order to implement the optimization of the compression within the layer 205. The packets are then transmitted via a physical wireless transmission channel 200 to a remote receiver (right-hand side of FIG. 2). This receiver receives the data at its radio access layer 207 then transmits them to a header decompression step 208 according to the invention. The data obtained with decompressed headers are then transmitted to the IP network layer 209 and then to the transport layer 210 before being deencapsulated 211 and transmitted to the recipient application 212.

The invention is therefore situated at the level of the layers 205, 208 handling the header compression and decompression mechanism. It requires information originating from the radio access layer 206, 207, in particular the size of the ATM cells.

In a first type of embodiment, the invention consists in modifying the choice of the compressed header type naturally determined by a header compression mechanism, for example conforming to the ROHC standard, by taking into account the constraints associated with the encapsulation of the compressed packets via the access layer.

FIG. 3 illustrates the application of the method according to the invention in the case of a packet 300 consisting of a network header 302 and a useful data section 303, for example an IP packet, encapsulated in a protocol data unit 301, or PDU of the access layer whose size L is a multiple of the size of the useful section of an ATM cell 306. Said protocol data unit 301 includes a padding section 304 used to complete the packet in order to obtain the size set by the application, and possibly a suffix 305. An ATM cell 307 comprises a header 308 and a useful section 306 that is generated by fragmenting the protocol data unit 301 into a number of sections equal to the ratio between the size L of the protocol data unit 301 and the a priori fixed size of the useful section 306 of an ATM cell 307. In the example illustrated in FIG. 3, the number of ATM cells obtained after fragmentation is four. A header compression mechanism according to the prior art makes it possible to obtain, from the network header 302, a compressed header 310 with a maximum compression level. The protocol data unit 309 obtained by encapsulation of the compressed packet containing the compressed header 310 and the useful section 303 has a large padding section 311. Since the respective sizes of the protocol data units 301 and 309 are the same, the compression scheme used does not ultimately offer a significant compression gain since it results in the generation of the same number of ATM cells as in the case of an uncompressed network header 302. Furthermore, by using a strongly compressed header, the performance in terms of packet losses is likely to be degraded as illustrated previously using FIG. 1. The method according to the invention then consists in using the size information of the protocol data unit 301 in order to predict the most suitable compressed header to be used in order to offer the best trade-off between robustness to errors and compression ratio. In the case illustrated in FIG. 3, a refresh header 312 having a low compression ratio and an enhanced robustness to errors is more suitable because its use makes it possible to reduce the size of the padding section 313. In particular, the use of this refresh header also called synchronization header enables the decompressor to be resynchronized and therefore to reduce the risks of propagation of errors appearing in bursts of packet losses preceding reception. A header with a lesser compression level 312 can also be used, the latter making it possible to increase the number of bits used for the coding of the header fields and therefore to increase the robustness to successive losses.

More generally, the method according to the invention aims to replace all or part of the padding section 304, 311, 313, if it exists, with a redundancy data section, said section being derived, for example, from the use of a compressed refresh header or a header with a lesser compression level. The choice of the type of compressed header to be used is made either on the basis of the estimated size of said packet including the compressed header or on its real size obtained by compressing it via the header compression mechanism. In the former case, the estimation is made pessimistically by using the information supplied by the header compression method concerning the possible compressed header sizes. In the latter case, knowledge of the real size of the packet with compressed header means having to compress the packet a first time, deduce its size therefrom, then make the decision involving modifying the type of compressed header or not in order to minimize the number of ATM cells generated.

FIG. 4 illustrates an example of use of the method according to the invention as described for FIG. 3 but this time in a situation in which the use of the compressed header with a maximum compression level leads to the elimination of the padding section and to the use of a more restricted number of ATM cells; in the case illustrated, only three cells are generated. The protocol data unit (PDU) 401 consisting of a network header 402, a useful data section 403, a padding section 404 and a suffix 405, is fragmented into four ATM cells 407 if no compression is applied to the network header 402. When a header compression mechanism is used, it produces the compressed header 410 which results in a significant reduction in the size L of the protocol data unit 401, 409. The fragmentation of said unit 409 then results in the generation of only three ATM cells instead of four. This saving is made by virtue of the high compression ratio obtained from the compressed header 410. The use of a less compressed header, for example a refresh header 411, although offering an enhanced robustness to transmission errors, would be detrimental from the overall compression point of view since it would lead to the use of a padding section 412 and an additional ATM cell.

In this situation, the method according to the invention leads to preferably choosing the compressed header which makes it possible to consume the smallest number of ATM cells.

In a second type of embodiment, the padding bits are replaced, no longer by redundant data deriving from a lesser compression of the header, but by redundant data generated from a correcting code applied to all or part of one or more compressed headers. The desired aim is still to reinforce the robustness to errors of the flow of compressed packets without increasing the bit rate.

FIG. 5 represents a flow of packets with compressed headers 501, 502, 503, 504, 505 comprising a useful data part denoted Pᵢ and a compressed header denoted Hᵢ. Said packets are fragmented in order to be encapsulated in cells of fixed size 506-515, generating padding sections 516, 517 within some of these cells. The presence or absence of padding in a cell is the direct result of the fragmentation process. These sections are present solely in order to retain a fixed size for each cell even though the size of the packets with compressed header is variable. The aim of the method according to the invention is notably to replace the padding sections 516, 517 with sections of the same size but comprising redundancy information hereinafter denoted Rⱼ. This redundancy can be obtained by using a correcting code applied to all or part of one or more headers. In the bottom part of FIG. 5, the succession of the compressed headers Hᵢ and of the redundancy sections Rⱼ is represented by observing the order in time. The headers H₁, H₂, H₃ positioned before a redundancy section R₁ are those which correspond to the compressed packets 501, 502, 503 the fragmentation of which has resulted in a padding section 516 of a size equal to that of R₁.

Hereinafter in the description, the size of a header Hᵢ is denoted hᵢ and that of redundancy block R is denoted rⱼ. The examples described take into account the case of use of a Reed-Solomon code as correcting code, but the method according to the invention can be extended to any type of systematic block correcting code for which the efficiency, the size of the information block and that of the redundancy block can be varied. In particular, the BCH (Bose, Ray-Chaudhuri, Hocquenghem) codes or the Reed-Muller codes can also be used.

FIG. 6 diagrammatically represents an example of redundancy generation by application of a correcting code to one or more compressed headers. The coding system according to the invention consists in generating a redundancy block Rⱼ, whose size corresponds to that of a padding area as explained previously, from a protection applied to the preceding headers which have not yet been protected. In the example of FIG. 6, the redundancy block R₁ is calculated from the headers H₁, H₂ and H₃, the redundancy block R₂ is calculated from the headers H₄ and H₅ and the redundancy block R₃ is calculated from the headers H₆ and H₇. One of the particular features of this coding scheme is that the length of the information to be coded and the length of the redundancy block generated are variable. Generally, if the headers Hᵤ, . . . , Hᵤ₊ₛ are protected by the redundancy block Rᵥ, the dimension k, expressed as a number of symbols, and the length r of the redundancy block of the code used, for example a Reed-Solomon code, are respectively equal to:

$$k = {\sum }_{i = 0}^{s} {h}_{u + i} and r = {r}_{v}$$

The length r of the redundancy block is fixed, because it is determined by the size of the corresponding padding section. In a first stage, the method according to the invention can be applied for a fixed size k, in this case, the efficiency Rate of the correcting code to be used to generate the redundancy block Rᵥ is equal to

$$Rate = \frac{k}{k + r} .$$

In the case of use of a Reed-Solomon code, the values k and r must observe the following inequality:

k+r≦2^{m}−1 (1)

in which 2^{m} is the size of the finite body used by the Reed-Solomon code. The values of m used in practice are, for example, 8 or 16.

One of the aims of the invention is notably to make the flow of packets with compressed headers robust to propagation errors which cause an entire packet to be lost on reception. In the case of use in which the headers H₁, H₂, H₃, H₄ and H₅ are protected by one and the same redundancy block R₁, if the headers H₂ and H₄ are for example lost, their respective lengths h₂ and h₄ are therefore not known and a receiver designed to decode the flow of protected packets according to the invention will not be able to position the header H₃ within the flow of information to be decoded. The problem identified by this example can, of course, be generalized to any flow of packets received within which some have been lost then resulting in an ambiguity concerning the position of the headers correctly received within the flow of information to be decoded. To overcome this problem, the method according to the invention sets an additional constraint on the correcting code. In the case where the Reed-Solomon code uses a finite body with 2⁸ symbols, it is imposed that the length k′ of the information block to be coded observes the following relationship:

k′+r≦2⁸−3.

In this case, the correcting code applied, of efficiency

$$\frac{k}{k + r} ,$$

for example a systematic Reed-Solomon code, will be shortened by considering that a number equal to k-k′ of additional information symbols are zero. The margin of k-k′ symbols enables the decoder to retrieve the correct length of the portion of erased data by using the error detection capability of said code. In the preceding example, the decoder performs an error detection on each of the possible positions of the header H₃ and makes it possible to validate the one which corresponds to the real position. Generally, the value of k-k′ should be greater than or equal to 16 bits in order to enable the decoder to perform a detection of the errors due to an incorrect positioning of a header correctly received within the flow of encoded data.

In a variant embodiment of the invention, a minimum header protection level may be determined from a measurement of the observed packets loss ratio on reception. Knowledge of the packet error ratio makes it possible to deduce, from theoretical performance curves of the selected correcting code or codes for example, the maximum efficiency Rateₘₐₓ of these correcting codes. If the efficiency Rate obtained via the method according to the invention as described previously is greater than the maximum efficiency Rateₘₐₓ, the invention then consists in reducing the length k′ of the information block to be coded by limiting the number of headers protected in order to obtain a code efficiency at most equal to Rateₘₐₓ.

FIG. 7 represents another variant embodiment of the invention for which the information window is sliding and the coding rate is constant. One of the aims of this variant is to make best use of the redundancy obtained by replacing the available padding sections.

The principle consists in setting a constant efficiency rate of the correcting code and in systematically using an information block of length k, such that

$$Rate = \frac{k}{k + r} .$$

In the case where k exceeds the overall length of the sum of the headers immediately preceding the redundancy block Rⱼ, the information block may contain all or part of one or more headers Hᵢ preceding the redundancy block Rⱼ₋₁ and which has already been protected by the generation of redundancy blocks after Rⱼ. This solution implies storage of the headers over a greater horizon than for the method described in FIG. 6. It also has the particular feature that one or more headers can be protected by one or more redundancy blocks which thus results in a difference in protection level between the headers.

An exemplary embodiment of the method according to the invention is represented in FIG. 7. The padding area R₁ is replaced by a redundancy block of the same size generated from the correcting coding of the information block 70 consisting of the concatenation of the headers H₁, H₂ and H₃. The padding area R₂ has a length r₂ such that the length of the information block to be encoded to observe the constant efficiency rate k/k+r of the correcting code entails concatenating, in addition to the headers H₄ and H₅, a part of the information block previously used and consisting of the headers H₁, H₂ and H₃. The information block to which the correcting code is applied consists on the one hand of the block 72 comprising the headers H₄ and H₅ and on the other hand of the block 71 comprising the headers H₂ and H₃ as well as a part of the header H₁. Finally, the redundancy block R₃ is generated in a similar way by calculating, from the efficiency of the code rate k/k+r and from the length r₃ of the available padding area, the length of the information block 73 to be encoded. In the example of FIG. 7, said block is made up of the concatenation of a part of the header H₆ and of the header H₇.

FIG. 8 illustrates another variant of the invention for which the coding scheme is adapted to the header compression protocols using a sliding window to compress the header fields having a predictable variation profile. For example, the ROHC protocol uses a sliding window mechanism of size w known by the acronym W-LSB which has the following effect: a header Hᵢ can be decompressed by the ROHC receiving entity if at least one of the preceding headers of the set {H_{i-w}, H^{1-w+1}, . . . , Hᵢ₋₁} has been successfully decompressed. The method according to the invention as described in FIG. 7 is then applied in a similar manner but by applying the correcting code only to a subset S of headers that is defined such that two consecutive headers are not separated by more than w positions. Formally, the subset S is described by the following relationship:

S={H_{b(0)}, H_{b(1)}, H_{b(2)}, . . . }

in which b is a strictly increasing function making a positive integer correspond to another positive integer and such that the following relationship is satisfied:

∀i>0,b(i)−b(i−1)≦w

The function b can, for example, be defined by b(i)=w.i which gives the subset S={H₀, H_{w}, H_{2w}, H_{3w} . . . }.

One of the advantages of this embodiment of the invention is that a protection level is applied to the elements of the subset S. The protected headers of the subset S are then used by the decompressor to ensure the decompression of the unprotected headers not included in the subset S. The protection-by-coding scheme here is complementary to the intrinsic protection mechanism of the header compression protocol. In practice, the protection of just one of the headers of the set {H_{i-w}, H_{i-w+1}, . . . , Hᵢ₋₁} helps to greatly increase the probability that i is correctly received and then enables the header decompression protocol to correctly decompress all the headers of said set.

Furthermore, if the length w of the sliding window of the compression protocol is increased, the subset S comprises fewer elements and requires the generation of less redundancy to ensure the same protection level. Conversely, if the quantity of redundancy generated by the correcting code increases, the latter is then capable of providing the same protection level to a greater number of headers, which may imply a reduction in the length of the sliding window of the compression protocol and therefore an improvement in the compression ratio.

The method according to the invention notably offers the advantage of significantly improving the robustness to errors of the flow of packets with compressed headers without causing the bit rate to increase since it exploits the padding areas that already exist within the flow and include no useful information.

1. A method for robustly transmitting a data flow in the form of packets Pi comprising at least one header Hi, said header being compressed via a first header compression step, said packets being fragmented into a succession of cells, said cells having an identical fixed size, said fragmentation resulting in the appearance of a padding section in the last of said cells wherein the space occupied by said padding section is used, at least partially, to insert redundancy data, the function of said redundancy data being to increase the robustness to transmission errors of said compressed header.

2. The method according to claim 1, wherein said redundancy data of said section Rj are obtained from the application of a correcting code to a useful data block of length k consisting of the concatenation of all or part of one or more compressed headers, said section Rj having a length rj equal to that of said padding section.

3. The method according to claim 2, wherein the efficiency of said correcting code is given by the ratio in which k is the length of the data block to be encoded which consists of the concatenation of the compressed headers of the packets present between said padding section and the immediately preceding padding section within said transmitted data flow.

4. The method according to claim 3, wherein the efficiency of said correcting code is less than a maximum efficiency determined from an estimation of the ratio of packets lost during the transmission and of the performance curve of said code, the length k of said data block to be encoded being limited to a value kmax obtained from said maximum efficiency and from the length rj of said padding section.

5. The method according to claim 2, wherein the efficiency of said correcting code is set to a constant value Rc and the dimension k of said useful data block to be encoded is obtained by the relationship, said useful data block comprising all or part of all the compressed headers Hi of the packets Pi present in said flow of packets to be transmitted before said padding section.

6. The method according to claim 5, wherein said first header compression step implements an encoding of the fields of said header using a sliding window of size w and said useful data block comprises all or part of a subset S of all the compressed headers Hi of the packets Pi present before said padding section, said subset S being characterized by the fact that two consecutive headers of the subset S are separated in said flow of data to be transmitted by at least a number of headers equal to the length w of the sliding window of the protocol for implementing the header compression step.

7. The method according to claim 2, wherein said correcting code is a systematic Reed-Solomon code or a systematic BCH code or a systematic Reed-Muller code, said code possibly being shortened and/or punctured.

8. The method according to claim 1, wherein said redundancy data are obtained by reducing the compression ratio applied by said first header compression step to said header Hi, said compression ratio being determined from an estimation of the size of the packet with compressed header.

9. The method according to claim 1, wherein said redundancy data are obtained via the following steps:
a step for determining the size of the padding section from the size of said packet with compressed header and from the fixed size of said cells,
a second step for compression of said header with a compression level making it possible to obtain a compressed header whose size is the closest possible integer less than the size of said padding section and which replaces the compressed header initially present.

10. The method according to claim 1, wherein the ROHC protocol or the IPHC protocol is used for the header compression.

11. The method according to claim 1, wherein the ATM protocol or the MPEG-TS protocol is used for the fragmentation of the packets with compressed header.

12. A system for robustly transmitting a data flow of packets with compressed headers comprising a transmitter, a receiver, and means for executing the steps of the method according to claim 1.

13. A system for robustly transmitting a data flow of packets with compressed headers comprising a transmitter, a receiver, and means for executing the steps of the method according to claim 2.

14. A system for robustly transmitting a data flow of packets with compressed headers comprising a transmitter, a receiver, and means for executing the steps of the method according to claim 3.

15. A system for robustly transmitting a data flow of packets with compressed headers comprising a transmitter, a receiver, and means for executing the steps of the method according to claim 4.

16. A system for robustly transmitting a data flow of packets with compressed headers comprising a transmitter, a receiver, and means for executing the steps of the method according to claim 5.

17. A system for robustly transmitting a data flow of packets with compressed headers comprising a transmitter, a receiver, and means for executing the steps of the method according to claim 6.

18. A system for robustly transmitting a data flow of packets with compressed headers comprising a transmitter, a receiver, and means for executing the steps of the method according to claim 7.

19. A system for robustly transmitting a data flow of packets with compressed headers comprising a transmitter, a receiver, and means for executing the steps of the method according to claim 8.

20. A system for robustly transmitting a data flow of packets with compressed headers comprising a transmitter, a receiver, and means for executing the steps of the method according to claim 9.
